(19) United States
(12) Patent Application Publication
(10) Pub. No.: US 2016/0275391 A1
(43) Pub. Date: Sep. 22, 2016

(54) MINIATURE RFID TAG WITH COIL ON IC PACKAGE

(71) Applicant: TEXAS INSTRUMENTS DEUTSCHLAND GMBH, Freising (DE)

(72) Inventors: Klemens Sattlegger, Munchen (DE); Johann Gross, Berglern (DE)

(73) Assignee: TEXAS INSTRUMENTS DEUTSCHLAND GMBH

(21) Appl. No.: 14/870,091

(22) Filed: Sep. 30, 2015

Related U.S. Application Data
(60) Provisional application No. 62/090,201, filed on Dec. 10, 2014.

(51) Int. Cl. G06K 19/077

(52) U.S. Cl. CPC G06K 19/07722; G06K 19/07779

(57) ABSTRACT

Disclosed examples include a miniature NFC/RFID tag and a method for making an NFC/RFID tag, in which an antenna is formed as a conductive trace on or in an IC package substrate, and a transponder die is mounted to the substrate with an electrical connection to the antenna by flip chip soldering to the substrate or wire-bonding, and optionally a material layer is formed over the transponder die and over at least a portion of the first side of the substrate.

### REFERENCE TO RELATED APPLICATION

Under 35 U.S.C. §119, this application claims priority to, and the benefit of, U.S. provisional patent application serial number 62/090,201, entitled “MINIATURE RFID TAG-COIL ON IC PACKAGE SUBSTRATE”, and filed on Dec. 10, 2014, the entirety of which is hereby incorporated by reference.

### TECHNICAL FIELD

The presently disclosed embodiments are related to RFID tags and more particularly to a miniature RFID tag with an antenna formed on/in an IC package substrate.

### BACKGROUND AND INCORPORATION BY REFERENCE

Near field communication (NFC) RFID technology (NFC/RFID) provides passive systems that can be interrogated and powered using energy from RF communications. Many potential applications, however, have severe size and space limitations. For example, minimum physical dimensions often prevent usage of NFC/RFID transponders for tagging smaller objects such as e.g., miniature tools and plastic vials. Current small tag solutions are either complex and thus not economically viable, fragile, too thick, and/or incapable of sufficient read/write range. For example, small NFC/RFID tags can be constructed using an integrated circuit (IC) and an external wire wound coil but these devices require multiple complex process steps and only provide limited read range. Although external antenna wire itself is inexpensive, the assembly process is expensive and the antenna wire is fragile and not typically protected by the packaging. Thus, existing NFC/RFID tag products and fabrication techniques do not provide adequate cost effective solutions for small products and other applications.

### SUMMARY

Disclosed examples include a miniature NFC/RFID tag including an antenna formed as a conductive trace on or in an IC package substrate, as well as a transponder die mounted to the substrate with an electrical connection to the antenna by e.g., flip chip connection to the substrate, printing, wire-bonding or other chip to substrate connection technologies. A material layer can be formed over the transponder die and a portion of the first side of the substrate. In some examples, multilayer PCB substrate structures are used, and the transponder die can be mounted to an external substrate side or embedded in or between two or more substrate layers. In certain examples, solder balls are provided on an exposed substrate side for mechanical mounting to a PCB or other product structure. In certain examples, the NFC/RFID tag can be mounted to a host circuit board and or more external solder balls can be used to provide electrical connection to the transponder to allow a processor to exchange data with the transponder die. In some examples, the NFC/RFID tag is a passive device and the transponder receives power from the interrogator antenna. The antenna in certain embodiments is sized and constructed to provide transmit and receive communication at frequencies of 0-30 MHz, for example 1-15 MHz in certain implementations, such as 13.56 MHz in one example. The miniature NFC/RFID tag is constructed using small substrates in certain examples, having length and width dimensions of approximately 10 mm or less.

### DESCRIPTION OF THE VIEWS OF THE DRAWINGS

FIG. 1 is a top perspective view of a first miniature NFC/RFID tag example with an antenna formed on a substrate and a flip chip NFC/RFID transponder die mounted to the substrate.

FIG. 2 is a top perspective view of a second miniature NFC/RFID tag example with an antenna formed on a PCB substrate and an NFC/RFID transponder die mounted to the PCB and connected to the antenna using wire bonding.

FIG. 3 is a flow diagram illustrating a method of fabricating a miniature NFC/RFID tag.

FIGS. 4-8 are top perspective and sectional side elevation views of the first miniature NFC/RFID tag of FIG. 1 at various stages of intermediate fabrication processing.

FIGS. 9-13 are top perspective and sectional side elevation views of the second miniature NFC/RFID tag of FIG. 2 at various stages of intermediate fabrication processing.

FIGS. 14-18 are top perspective and sectional side elevation views of another miniature NFC/RFID tag using a multilayer substrate structure at various stages of intermediate fabrication processing.

FIGS. 19-22 are top perspective and sectional side elevation views of another miniature NFC/RFID tag using a multilayer substrate structure with the NFC/RFID transponder die embedded between substrate layers at various stages of intermediate fabrication processing.

### DETAILED DESCRIPTION

In the drawings, like reference numerals refer to like elements throughout, and the various features are not necessarily drawn to scale. In the following discussion and in the claims, the terms “including”, “includes”, “having”, “has”, “with”, or variants thereof are intended to be inclusive in a manner similar to the term “comprising”, and thus should be interpreted to mean “including, but not limited to . . . ” Also, the term “couple” or “couples” is intended to include indirect or direct electrical connection or combinations thereof. For example, if a first device couples to or is coupled with a second device, that connection may be through a direct electrical connection, or through an indirect electrical connection via one or more intervening devices and connections.

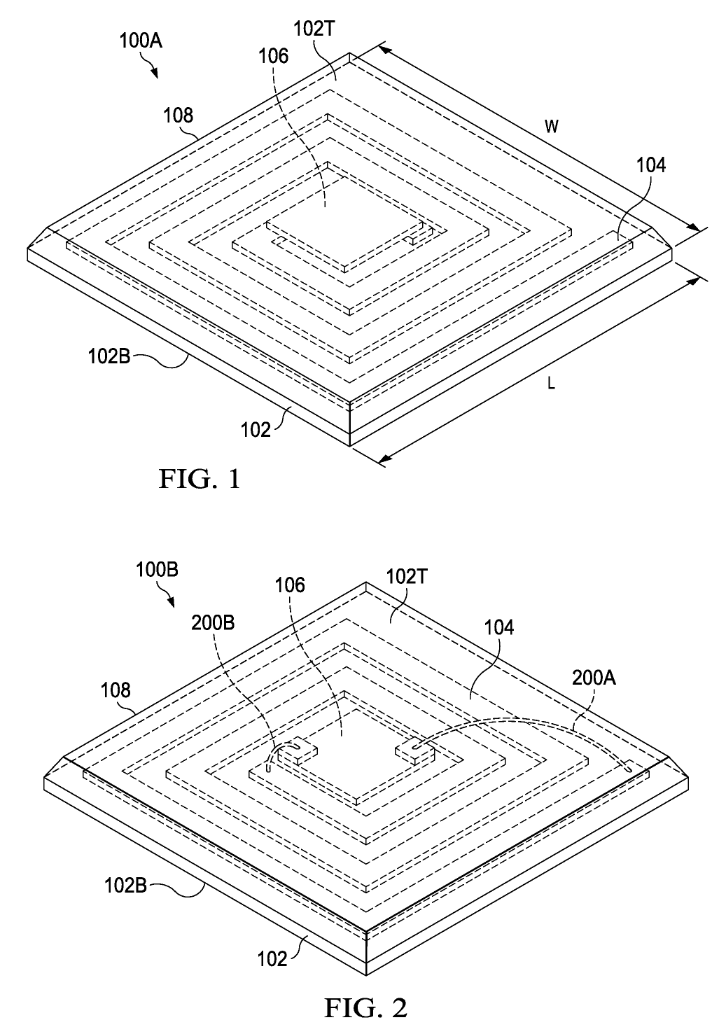

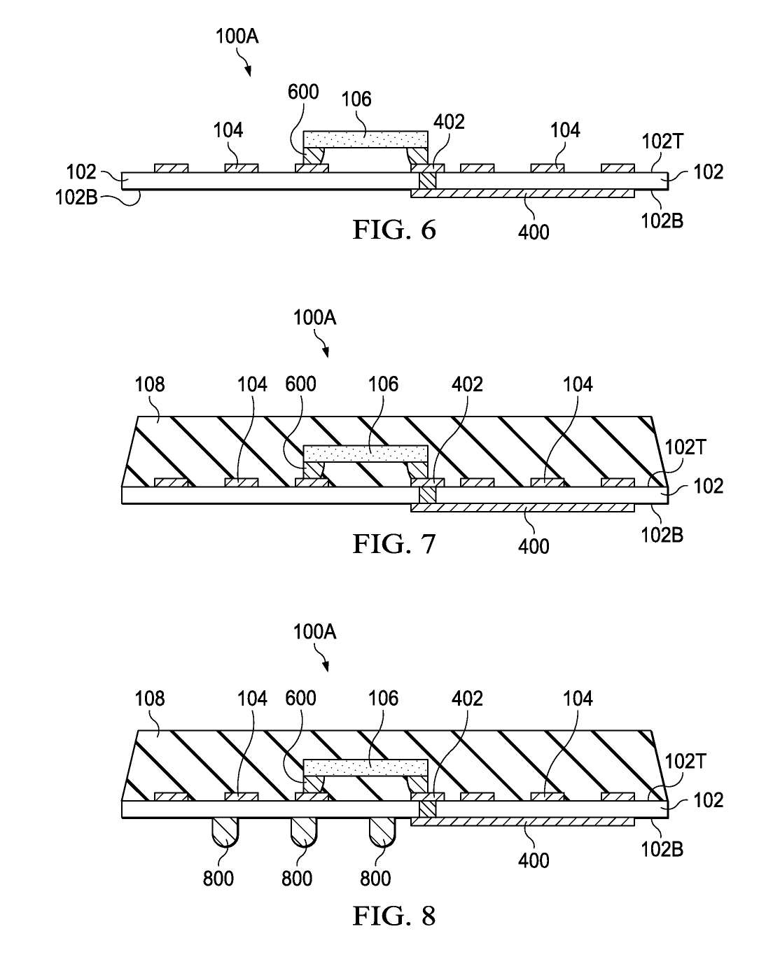

FIG. 1 illustrates a first miniature NFC/RFID tag 100A including a substrate 102 with a first or top side 102T and an antenna 104 formed as a conductive trace on the top side 102T of the substrate 102. Various NFC/RFID tag examples are collectively and individually denoted 100. The substrate 102 in certain examples has a length dimension L and a width dimension W, each being between 1 and 10 mm in certain examples. The substrate 102 includes an opposite second or bottom side 102B seen below in FIGS. 6-8 and 10-13. The NFC/RFID tag 100A also includes a transponder die 106 mounted to the substrate 102, having first and second electrical connections through solder pads (not shown in FIG. 1) to the antenna trace 104. The transponder die 106 is constructed using known semiconductor processing steps, and includes one or more electrical connections such as bottom side solder balls or other conductive features for electrical connection to the antenna 104. The transponder die 106 includes various internal circuits (not shown) for operation of an NFC/RFID tag 100. For example, the transponder die 106 includes a demodulator for demodulating RF communications signals received via the antenna 104, as well as a modulator circuit for modulating outgoing data transmitted from the transponder 106 through the antenna 104. The transponder die 106 also includes control logic such as a microprocessor or microcontroller with associated electronic memory for operating the demodulator in the modulator and for storing data and programming instructions. In addition, the transponder die 106 includes a rectifier circuit to rectify energy received by way of the antenna 104 to provide power for the circuitry of the transponder die 106. In one example, the transponder die 106 is a passive circuit operated exclusively through power received by way of the antenna 104. In this regard, the antenna structure 104 in various examples is configured by trace size, antenna length, and other structural design parameters to transmit and receive RFID frequencies and constitutes a magnetic antenna to power the transponder die 106 using energy received by RF communications from an external device (e.g., NFC/RFID reader, not shown). In one example, the antenna 104 is an inductive coupled coil configured to transmit and receive frequencies of 0-30 MHz, such as 1-15 MHz in certain implementations. For example, the antenna will 104 is configured for near field communication (NFC) RF/ID communications at 13.56 MHz. The use of the conductive on or in the PCB substrate 102 forms an air-core inductor capable of powering the passive NFC/RFID transponder die 106. The NFC/RFID tag 100A further includes a molded material layer 108 formed over the transponder die 106 and over all or at least a portion of the first side 102T of the substrate 102. Any suitable material 108 a can be used to cover all or portions of the transponder die 106 and portions of the substrate 102. In certain examples, the material 108 encloses or covers the entire substrate 102 and the transponder die 106.

In one example, the substrate 102 is a single layer or printed circuit board (PCB) structure formed of any suitable PCB material, such as FR4 glass-reinforced epoxy laminate sheets. In one example, a 325 μm square HL832NS substrate material 102 can be used, with a 175 μm silicon-based transponder IC die 106 soldered by flip chip techniques to one or more conductive pads (e.g., 402 in FIG. 4 below) on the first side 102T of the substrate 102 in order to form one or more electrical connections from the transponder 106 to the antenna trace 104, for example by flip chip soldering (e.g., reflow) techniques. In one example, the package height is around 680 μm for the entire NFC/RFID tag assembly 100. In other non-limiting examples, the length and width L, W dimensions can be 1-10 mm or even less. In one example, 10 μm copper traces are used to form the antenna 104. In one example, one or more 30 μm connector pads with solder resist areas are provided on the first surface 102T for connecting conductive features on the bottom side of the transponder die 106 to make one or more corresponding electrical connections to the antenna trace 104. The connection can be by any suitable techniques, including without limitation soldering, welding, ultrasonic connection, conductive or non-conductive adhesives. In one example, the transponder die 106 includes conductive features on a bottom side thereof which are soldered to corresponding solder pads on the first side 102T of the substrate 102. In another example, the antenna 104 is formed as a conductive structure in the substrate 102, with one or more electrically conductive connections to corresponding externally accessible solder pads on the side 102T to allow connecting and mounting of the transponder die 106 to form one or more electrical connections to the antenna 104.

The fabrication of the antenna 104 as part of the substrate 102 provides a cost efficient miniature NFC/RFID tag 100, and facilitates assembly of small sized NFC/RFID tags with sufficient performance to enable short distance applications. For example, the NFC/RFID tag 100 can be easily molded into, or mounted on small products such as plastic vials for medical uses or other products in which NFC NFC/RFID tags are associated with small products for authentication or other uses. In certain examples (e.g., FIGS. 8 and 13 below) solder balls 800 can be formed on the bottom side 102B of the substrate 102 to facilitate mechanical mounting of the NFC/RFID tag 102 an associated product (not shown). The NFC/RFID tag 100 can be mounted to a host product by a variety of other techniques, such as adhesives or by other mechanical fastening apparatus (not shown).

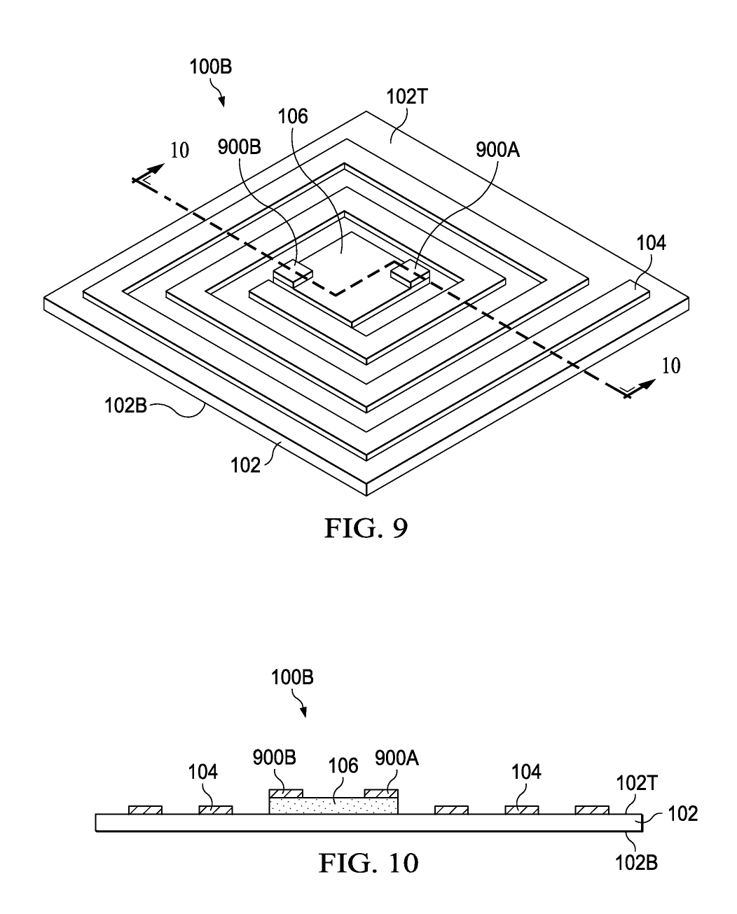

FIG. 2 shows another example NFC/RFID tag 100B including a substrate 102 and an antenna 104 formed on or in the substrate 102 as described above. In addition, the NFC/RFID tag 100B of FIG. 2 includes an NFC/RFID transponder die 106 mounted to the substrate using any suitable mounting techniques. In one example, the NFC/RFID transponder die 106 is glued to the top side 102T of the substrate 102 using adhesives (not shown). In this example, the antenna trace 104 includes solder pads at first and second ends of the antenna trace 104, and the transponder die 106 includes conductive connection structures or contacts on a top side thereof (e.g., contacts 900 in FIGS. 9-13 below), and wires 200A and 200B are soldered between corresponding transponder die conductive contacts and antenna solder pads to form electrical connections between the transponder die 106 and the antenna 104. As with the example of FIG. 1, the NFC/RFID tag 100B in FIG. 2 includes a material layer 108 formed over the transponder die 106 and all or a portion of the first side 102T of the substrate 102.

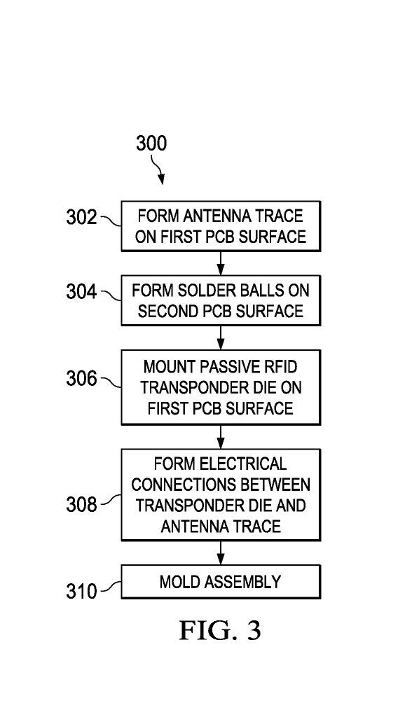

Referring now to FIGS. 3-8, FIG. 3 shows an example method or process 300 of fabricating a miniature NFC/RFID tag (e.g., tags 100 in FIGS. 1 and 2), and FIGS. 4-8 illustrate the NFC/RFID tag 100A of FIG. 1 at various stages of fabrication according to the method 300 in FIG. 3. Although the method 300 is illustrated in FIG. 3 and described as a series of acts or events, the methods of the present disclosure are not limited by the illustrated ordering of such acts or events except as specifically set forth herein. Except as specifically provided hereinafter, some acts or events may occur in different order and/or concurrently with other acts or events apart from those illustrated and described herein, and not all illustrated steps may be required to implement a process or method in accordance with the present disclosure. The method 300 in one example leverages an industrial IC packaging process, taking advantage of scale and processes enabling maximum cost efficiency, economies of scale and mechanical stability. The method 300 includes forming an antenna at 302 as a conductive trace on or in a first side of a printed circuit board (PCB) substrate. For example, the antenna 104 is formed as a trace on the top side 102T of the substrate 102 in FIG. 4. In addition, as shown in FIG. 4, the solder pads 402 are formed on the top side 102T of the substrate 102. In this example, moreover, a bottom-side trace 400 is formed on the lower side 102B of the substrate 102 (e.g., FIG. 6) and one or more top-to-bottom conductive vias (not shown in FIG. 4) are used to connect one end of the top-side antenna trace 104 with the bottom-side trace 400, and to electrically connect one of the top-side solder pads 402 with the bottom-side trace 400.

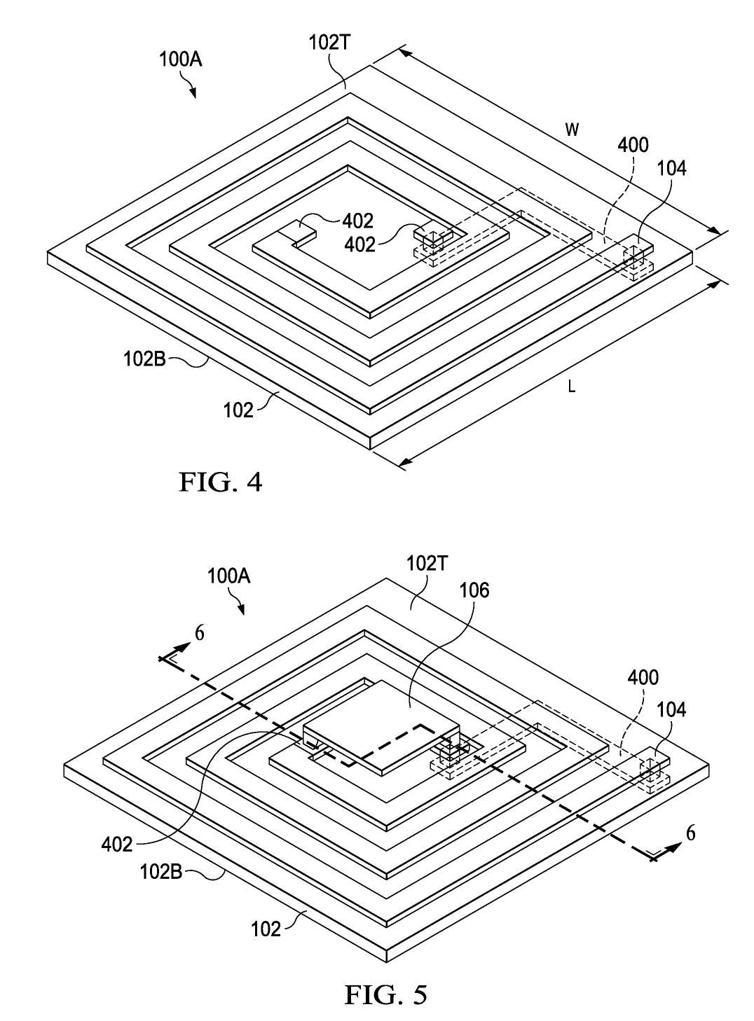

In certain examples, one or more solder balls are formed on the second (e.g., bottom) PCB surface at 300 for in FIG. 3, shown as solder balls 800 on the bottom side 102B of the substrate 102 in FIG. 8. The solder balls 800 can be formed at any suitable point in the fabrication process, for example, before mounting the transponder die onto the PCB 102. In other embodiments, no solder balls are formed on the substrate, and the process step 304 is omitted. At 306 in FIG. 3, a passive NFC/RFID transponder die (e.g., die 106) is mounted on the first PCB surface. At 308, one or more electrical connections are formed between the transponder die and the antenna trace of the substrate 102. FIG. 5 illustrates one example in which flip chip reflow soldering processing is used at 306 and 308 of FIG. 3 in order to mount the passive NFC/RFID transponder die 106 to the top side 102T of the substrate 102. As further seen in FIG. 6, the transponder die 106 includes bottom side conductive contact structure 600 which are soldered to the solder pads 402 on the top side 102T of the substrate 102 in order to both mechanically mouth the transponder die 106 on the PCB surface (306 in FIG. 3) and to form electrical connections between the transponder die 106 and the antenna trace 104 (308 in FIG. 3. At 310 in FIG. 3, the assembly is molded or any other suitable process is used to form a material layer 108 over the transponder die 106 and over at least a portion of the substrate 102, as shown in FIG. 7. This completes one example of an NFC/RFID tag 100A. As previously discussed, another example is shown in FIG. 8, including one or more solder balls 800 formed on a second side (e.g., the bottom side 102B) of the substrate 102.

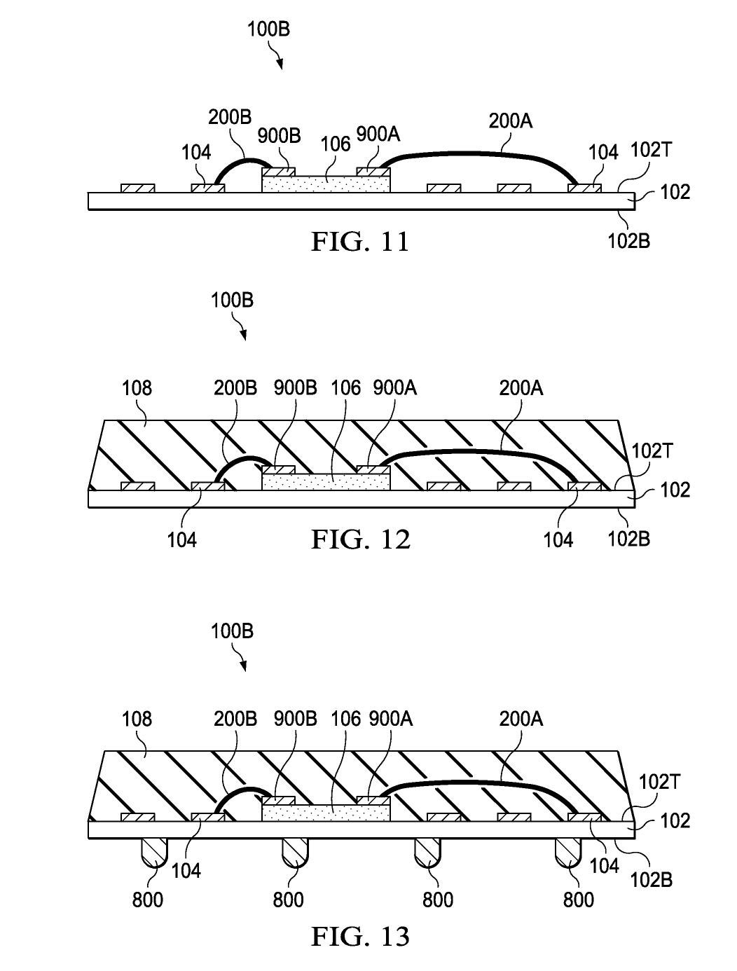

Referring now to FIGS. 2, 3 and 9-13, the process 300 can be used to fabricate the second example NFC/RFID tag 100B shown in FIG. 2. As seen in FIGS. 9 and 10, a trace 104 is formed on the first side 102T of the substrate 102 (302 in FIG. 3), and a passive NFC/RFID transponder die 106 is mounted on the first PCB surface 102T (306 in FIG. 3). In this example, the NFC/RFID transponder die 106 can be glued or otherwise affixed to the substrate 102 using any suitable technique, which need not include soldering. In this example, however, the electrical interconnection of the transponder die 106 with the antenna trace 100 for include soldering (308 in FIG. 3) a wire 200 between the transponder die 106 and the antenna 104. In the example of FIG. 11, a first wire 200A is soldered between a first electrical contact 900A on the top side of the transponder die 106 to a first solder pad on one end of the antenna trace 104, and a second wire 200B is soldered from a second contact 900B on the transponder die 106 to a solder pad connected to the other end of the antenna trace 104. The NFC/RFID tag 100B is then molded (310 in FIG. 3) to form a material layer 108 over the transponder die 106 and over a portion of the substrate 102 as shown in FIG. 12. In certain examples, one or more solder balls 800 are formed on the second (e.g., bottom) side 102B of the substrate 102 as shown in FIG. 13. As previously mentioned, the solder balls 800 in certain examples facilitate flip chip type assembly process steps to mount the NFC/RFID tag 100B to a host product through reflow soldering to provide mechanical support for the NFC/RFID tag 100B.

In certain examples, bottom-side solder balls 800 or other externally accessible electrical contact structures can be electrically connected to contacts or terminals of the NFC/RFID transponder die 106 to form electrical connections between a host structure and one or more internal circuits of the transponder die 106. For example, a serial peripheral interface (e.g., SPI) may be established between a processor of the transponder die 106 and a processor or other circuit component or components of a host circuit board (not shown) to which the NFC/RFID tag 100B is soldered. In one possible application, this allows use of the NFC/RFID tag 100 to exchange data with a host system processor. For instance, the transponder die 106 may include one or more sensor components (not shown) which sense one or more environmental conditions and store corresponding data in the NFC/RFID transponder die, which a host system can retrieve through such a data interface, facilitated by electrical connections using bottom side solder balls 800 or other conductive circuit structures that are externally accessible, while other solder balls 800 facilitate mechanically mounting the NFC/RFID tag 100 to the host system. The tag 100 can include other components such as separate sensor dies, peripherals as well as passive components also mounted on or in the same substrate 102. In this regard, the structure on/in the substrate can include the antenna as well as interconnects between such secondary components.

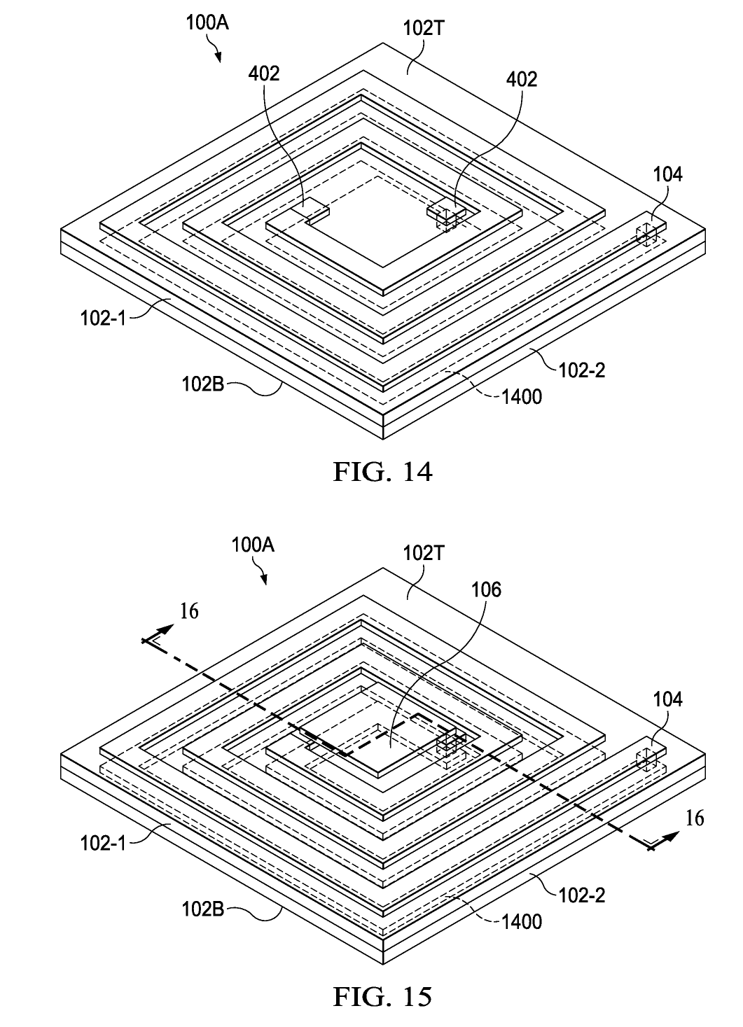

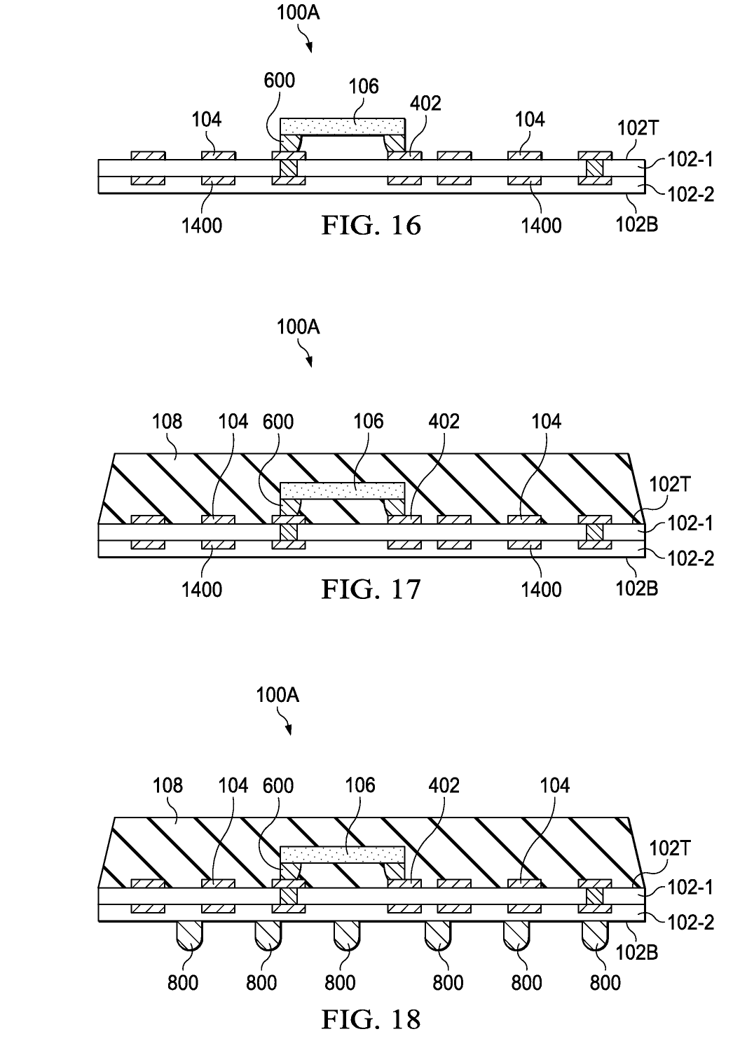

Referring also to FIGS. 14-18, another example NFC/RFID tag embodiment 100A is illustrated undergoing fabrication processing. In certain embodiments, the substrate 102 is a multilayer printed circuit board or other multilayer IC packaging structure with multiple layers. In the example of FIGS. 14-18, the PCB includes a first layer 102-1 and a second layer 102-2 mounted to one another using conventional multilayer PCB fabrication techniques and materials. In this example, moreover, the antenna 104 includes conductive traces 104 and 1400 formed on or in at least two PCB layers of the substrate 102. For example, the substrate 102 in FIG. 14 includes a first antenna trace 104 formed on the top side 102T of the first substrate layer 102-1, as well as a second antenna trace 1400 formed on or in substrate layer 102-2. As seen in FIGS. 16-18, the second antenna trace 1400 is formed generally beneath the first trace 104, although other relative configurations are possible. In addition, the substrate 102 includes one or more via structures (not numerically designated, but shown in FIGS. 16-18) forming conductive electrical interconnections between the upper and lower antenna traces 104 and 1400. As seen in FIGS. 15 and 16, the transponder die 106 is connected to solder pads on the top side 102T of the upper PCB layer 102-1 in order to form electrical interconnections with the antenna traces 104 and 1400. The assembly is then molded to form the material layer 108 as shown in FIG. 17. In certain examples, one or more solder balls 800 can be formed on the bottom side 102B of the multilayer substrate structure 102 as shown in FIG. 18.

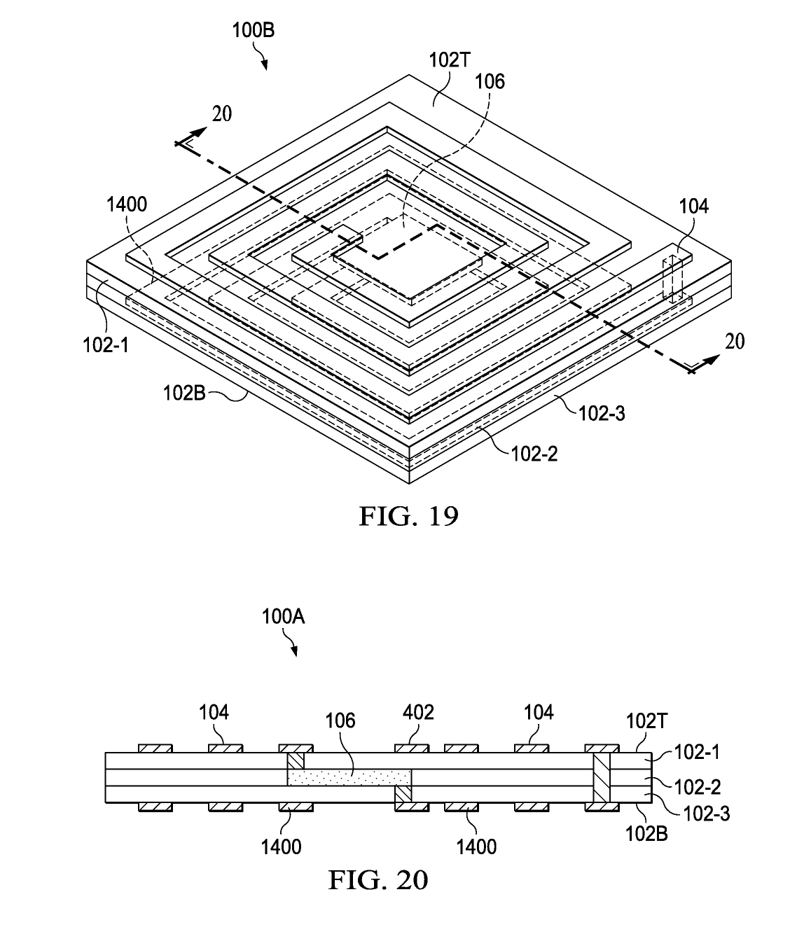

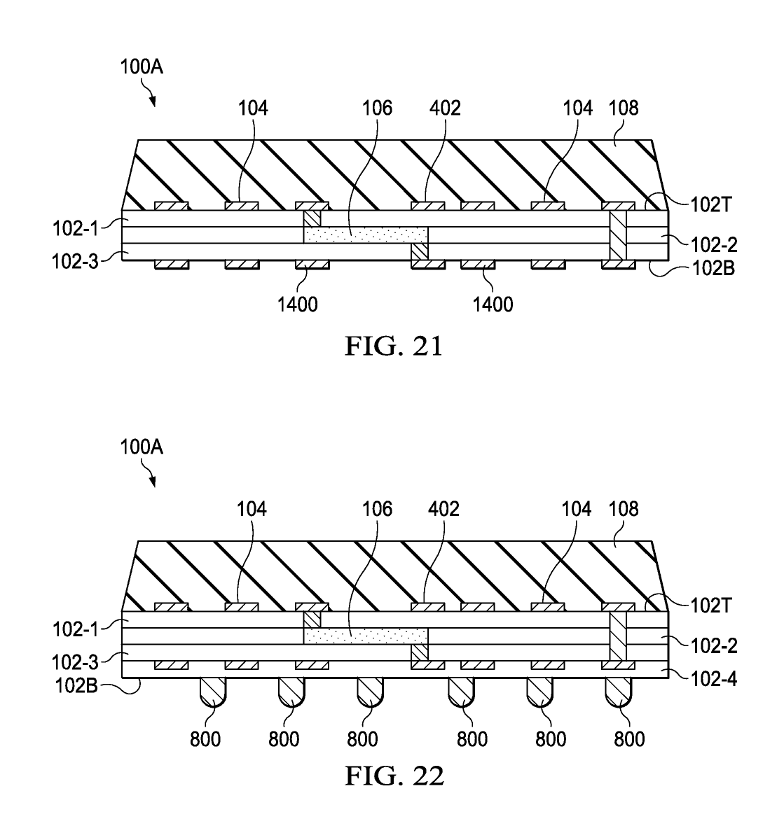

Referring now to FIGS. 19-22, in other examples of an NFC/RFID tag 100, the substrate 102 can include any integer number layers. The example tag 100A of FIGS. 19-22 includes three substrate layers 102-1, 102-2 and 102-3, allowing up to six conductive layers for routing. In this case moreover, the antenna is an inductive coupled coil configured to transmit and receive frequencies of 0-30 MHz, such as 1-15 MHz and provides an NFC/RFID communications with a first antenna trace 104 formed on the top side 102T of the first layer 102-1, as well as a second or lower antenna trace 1400 formed on the bottom side 102B of the lower PCB layer 102-3 as shown in FIG. 20. In addition, the transponder die 106 is embedded into or between at least two layers of the substrate 102 as shown in FIGS. 20 and 21. Any suitable circuit board manufacturing techniques can be used in order to include or embed the NFC/RFID transponder die 106 between or into one or more layers of a multilayer PCB structure 102. The As seen in FIG. 21, the multilayer NFC/RFID tag assembly 100A is molded to form the material layer 108 over the transponder die 106 and a portion of the substrate 102. FIG. 22 shows another example in which a fourth PCB layer 102-4 is used, with the lower antenna trace 1400 formed on or in the fourth layer 102-4, and one or more solder balls 800 are formed on the bottom side 102B of the lower -most PCB layer 102-4.

In practice, fewer or more PCB layers can be provided, and a desired number of antenna turns and overall antenna links can be designed for any specific application by including the appropriate number of layers for a given set of overall length and width dimensions for the substrate 102 and a given trace width dimension. In certain examples, the transponder die 106 and the antenna 104 are on the same side of the substrate 102. In other examples, the transponder die 106 is on one side and the antenna 104 is partially formed on both sides of the substrate 102. In another example, the transponder die 106 is mounted on one side and the antenna 104 is formed on or in a second side of the substrate 102. In another example, the transponder die 106 is mounted on one side of the substrate 102 and the antenna 104 is formed on or in more than one layer of the substrate 102. In another example, the transponder die 106 is formed between layers, and the antenna 104 is formed on or in 1 or more layers of the substrate 102. In this manner, near field NFC/RFID communications can be provided in a cost-efficient assembly of small size (e.g., miniature) NFC/RFID tags 100, without the cost and complexity of externally wound wire antennas. The disclosed examples utilize substrates and fabrication processing of a standard IC package to create reliable RFID/NFC tag antennas, and described examples can include an inductive coil formed through an etching, printing or lamination process on and/or in the substrate 102. The RFID/NFC transponder die 106 is then mounted on the substrate 102 and connected to the antenna 104 connections either through flip chip assembly, wire bonding or lamination. The material layer 108, moreover, can be formed using known IC packaging processing, such as molding. The disclosed examples provide small, compact and mechanically robust NFC/RFID tags 100 which can then be further processed for association with a given product, for example, through plastic molding, soldering, and gluing, or the like.

The above examples are merely illustrative of several possible embodiments of various aspects of the present disclosure, wherein equivalent alterations and/or modifications will occur to others skilled in the art upon reading and understanding this specification and the annexed drawings. In addition, although a particular feature of the disclosure may have been disclosed with respect to only one of multiple implementations, such feature may be combined with one or more other features of other embodiments as may be desired and advantageous for any given or particular application. Also, to the extent that the terms “including”, “includes”, “having”, “has”, “with”, or variants thereof are used in the detailed description and/or in the claims, such terms are intended to be inclusive in a manner similar to the term “comprising”.

The following is claimed:

1. A near field communications radio frequency ID (NFC/RFID) tag, comprising:
an IC package substrate including a first side, wherein the substrate is a printed circuit board (PCB) material or a laminate;
an antenna formed as a conductive trace on or in the substrate to transmit and receive data; and
a transponder die mounted to the substrate with an electrical connection to the antenna.

2. The NFC/RFID tag of claim 1, further comprising one or more solder balls formed on a second side of the substrate.

3. The NFC/RFID tag of claim 1, comprising a material layer formed over the transponder die and a portion of the first side of the substrate.

4. The NFC/RFID tag of claim 1, wherein the transponder die receives power from the antenna.

5. The NFC/RFID tag of claim 1, wherein the transponder die includes a conductive contact connected to the first side of the substrate to form an electrical connection to the antenna.

6. The NFC/RFID tag of claim 5, wherein the antenna is a conductive trace formed on an outer surface of the first side of the substrate, and wherein the conductive contact of the transponder die is connected to the conductive trace.

7. The NFC/RFID tag of claim 6, wherein the substrate is a printed circuit board (PCB) material.

8. The NFC/RFID tag of claim 5, further comprising one or more solder balls formed on a second side of the substrate.

9. The NFC/RFID tag of claim 1, wherein the transponder die includes a conductive contact, the NFC/RFID tag further including a wire connected to the conductive contact of the transponder die and connected to the antenna.

10. The NFC/RFID tag of claim 9, wherein the antenna is a conductive trace formed on an outer surface of the first side of the substrate, and wherein the wire is soldered to the conductive trace.

11. The NFC/RFID tag of claim 10, wherein the substrate is a printed circuit board (PCB) material.

12. The NFC/RFID tag of claim 9, further comprising one or more solder balls formed on a second side of the substrate.

13. The NFC/RFID tag of claim 1, wherein the antenna is an inductive coupled coil configured to transmit and receive frequencies of 0-30 MHz.

14. The NFC/RFID tag of claim 1, wherein the antenna is configured for near field communication (NFC) RFID communications at 13.56 MHz.

15. The NFC/RFID tag claim 1, wherein the substrate has a length of approximately 10 mm or less, and a width of approximately 10 mm or less.

16. The NFC/RFID tag of claim 1, wherein the substrate is a multilayer structure with multiple layers.

17. The NFC/RFID tag of claim 16, wherein the antenna includes conductive traces formed on or in at least two layers of the substrate.

18. The NFC/RFID tag of claim 17, wherein the transponder die is embedded into or between at least two layers of the substrate.

19. The NFC/RFID tag of claim 16, wherein the transponder die is embedded into or between at least two layers of the substrate.

20. A method of fabricating a miniature NFC/RFID tag, the method comprising:
forming an antenna as a conductive trace on or in an IC package substrate, the antenna designed to transmit and receive frequencies of 0-30 MHz;
mounting a transponder die to the substrate; and
connecting a wire between the transponder die and the antenna.

21. The method of claim 20, further comprising forming solder balls on a side of the substrate.

22. The method of claim 20, comprising forming a material layer over the transponder die and over a portion of the substrate.

23. The method of claim 20, wherein the antenna is formed as a magnetic antenna.

24. A method of fabricating a miniature NFC/RFID tag, the method comprising:
forming an antenna as a conductive trace on or in a first side of an IC package substrate;
connecting an electrical contact of a transponder die to a portion of the antenna on the first side of the substrate; and
forming a material layer over the transponder die and over a portion of the substrate.

25. The method of claim 24, further comprising forming solder balls on a second side of the substrate.

26. The method of claim 24, wherein the antenna is sized to transmit and receive frequencies of 0-30 MHz.

27. The method of claim 24, wherein the antenna is adapted to provide power to the transponder die.
